(19) United States
(12) Patent Application Publication
(10) Pub. No.: US 2026/0300237 A1
(43) Pub. Date: Oct. 1, 2026

(54) ADAPTIVE DATA QUALITY MONITORING

(71) Applicant: NETFLIX, INC., Los Gatos, CA (US)

(72) Inventors: Tulika BHATT, San Jose, CA (US); Saurabh Yadunandan JALUKA, San Jose, CA (US); Sujay JAIN, San Francisco, CA (US)

(21) Appl. No.: 19/405,136

(22) Filed: Dec. 1, 2025

Related U.S. Application Data
(60) Provisional application No. 63/781,014, filed on Mar. 31, 2025.

(51) Int. Cl. G06F 16/21

(52) U.S. Cl. CPC G06F 16/21

(57) ABSTRACT

One embodiment sets forth a technique for generating data quality metrics that includes identifying an input data stream comprising a plurality of events, determining at least one of a schema or a data governance rule associated with the input data stream, providing the schema or data governance rule to the input data stream, wherein the input data stream outputs events according to the schema or the data governance rule, the events being stored in a data warehouse, calculating a plurality of data quality metrics associated with the events from the input data stream that are stored in the data warehouse, and generating one or more alerts to a downstream data consumer based on the data quality metrics and the events stored in the data warehouse.

### CROSS-REFERENCE TO RELATED APPLICATIONS

The present application claims the benefit of U.S. Provisional Application titled, “TECHNIQUES FOR IMPLEMENTING ADAPTIVE DATA QUALITY MONITORING”, filed on Mar. 31, 2025, and having Ser. No. 63/781,014. The subject matter of this related application is hereby incorporated herein by reference.

### BACKGROUND

### Field of the Various Embodiments

Embodiments of the present disclosure relate generally to computer science and computer networks, and more specifically, to adaptive data quality monitoring.

### Description of the Related Art

Many organizations rely heavily on data to support a wide range of operations, analyses, and decision-making processes. Data enables organizations to gain valuable insights, improve workflows, and achieve strategic objectives. Data quality is essential in large-scale streaming services to assess the operational status of a service. For example, high quality data regarding the operational status of a service is important for determining service reliability, performing debugging tasks, or fulfilling compliance and security requirements. Furthermore, high-quality data logs help operators understand the current operational status of a service and anticipate whether the service is experiencing technical or other issues. In the case of a streaming media service, high-quality data is also important to provide user-facing features, such as high-quality media recommendations or accurate billing calculations.

Obtaining high-quality log data presents technical challenges in large-scale streaming services for various reasons. Traditional monitoring systems often use static thresholds to assess performance metrics. However, static thresholds often fail to adapt to the changing and evolving nature of streaming data, where data volume and patterns fluctuate over time. Other solutions rely on batch processing of data for validation before the data is used by downstream consumers. However, the continuous, unbounded nature of data streams in a streaming environment often requires real-time assessment with minimal latency from the moment data is generated. If upstream data generators in a streaming environment generate low-quality data, then maintaining acceptable service levels or meeting other operational objectives becomes challenging.

As the foregoing illustrates, what is needed in the art are more effective techniques for assessing the quality of data that is generated by upstream data generators to improve the performance of downstream data consumers.

### SUMMARY

One embodiment sets forth a technique for generating data quality metrics that includes identifying an input data stream comprising a plurality of events, determining at least one of a schema or a data governance rule associated with the input data stream, providing the schema or data governance rule to the input data stream, wherein the input data stream outputs events according to the schema or the data governance rule, the events being stored in a data warehouse, calculating a plurality of data quality metrics associated with the events from the input data stream that are stored in the data warehouse, and generating one or more alerts to a downstream data consumer based on the data quality metrics and the events stored in the data warehouse.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that the disclosed techniques provide a mechanism to monitor and improve the quality of data that is reported by data producers in a streaming service. The disclosed techniques provide a proximity-oriented monitoring strategy so that data quality can be assessed by placing monitoring mechanisms with the data producers rather than with data consumers. The disclosed techniques also evaluate data quality using multiple dimensions that include completeness, freshness, accuracy, and consistency. The disclosed techniques also enable the assessment of data quality degradation based on probabilistic models that forecast downstream consequences of data quality degradation. As a result, alerts and notifications that are generated based on data generated by data producers is more reliable, resulting in enhanced reliability and responsiveness of streaming data pipelines.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments;

FIG. 2 is a more detailed illustration of the server device of FIG. 1, according to various embodiments;

FIG. 3 sets forth a flow diagram of method steps for storing data from an input data stream into a data store maintained by data consumer system, according to various embodiments; and

FIG. 4 sets forth a flow diagram of method steps for generating one or more data quality metrics based on data from an input data stream, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described herein, data associated with events in environments such as streaming services or other network-accessible services that serve a large number of users is utilized for various purposes. The internal structuring of such services often results in different organizations or teams being responsible for different portions of the services. For example, one team might be responsible for maintaining the front-end user experience while another team handles user authentication. A different team might then be responsible for maintaining a data warehouse in which events relating to security and user authentication are housed. Yet another team might be responsible for responding to security-related events that occur with respect to the front-end user experience or user authentication events. Coordination between all of these different teams relies upon high-quality data being generated and subsequently stored in the data warehouse. Additionally, coordination between these teams depends on a consistent and reliable alert mechanism to ensure that, when an alert is generated in response to an event occurring within the network-accessible service, the alert is trustworthy and timely. Accordingly, high-quality data with respect to events or data that is logged in such a service means that the data that is being stored in a data warehouse meets high standards with respect to at least four metrics: completeness, freshness, accuracy, and consistency.

Data completeness means that the data that is being logged has minimal data loss and is relatively complete. Data freshness measures the timeliness or temporal relevance of the data that is being housed in the data warehouse. Data accuracy measures correctness and accuracy of the data. Data consistency checks for coherence across different sources and transformations of the data or events being stored in the data warehouse.

In some organizations, the quantity of events occurring and thus the amount of data that is being logged in a data warehouse can be extremely large. Additionally, segmentation among teams can result in one team being responsible for maintaining data logs for the services of another team over which such a team has little or no control over the codebase or design of a service. As a result, low-quality data is often logged in a data warehouse, which impairs the ability of the organization to respond to events or improve decision-making.

To address the foregoing drawbacks, techniques for generating high-quality data logs associated with events occurring in a network-accessible service are disclosed. The events that are generated and logged in a data warehouse adhere to schemas or data governance rules that are enforced at the source of the input data stream. Transformations in the data can also be monitored by a lineage tracking service that can maintain consistency in the data corresponding to the events. Metrics are also calculated to numerically express data quality indicators, such as accuracy, freshness, consistency, and completeness. Additionally, alert mechanisms ensure that downstream consumers of the data can respond to different types of events or indicators reflected in the data being stored in the data warehouse.

One technical advantage of the disclosed techniques relative to the prior art is that the disclosed techniques provide a mechanism to monitor and improve the quality of data that is reported by data producers in a streaming service. The disclosed techniques provide a proximity-oriented monitoring strategy so that data quality can be assessed by placing monitoring mechanisms with the data producers rather than with data consumers. By placing monitoring mechanisms with the data producers and requiring that data generated by the data producer conform to schema or data governance rules, data quality is improved because schema and governance rule conformance is performed at the time of data generation. The disclosed techniques also evaluate data quality using multiple data dimensions that include completeness, freshness, accuracy, and consistency. The disclosed techniques also allow for assessment of data quality degradation based on probabilistic models that forecast downstream consequences of data quality degradation. As a result, alerts and notifications that are generated based on data generated by data producers is more reliable, resulting in enhanced reliability and responsiveness of streaming data pipelines.

These technical advantages represent one or more technological improvements over prior art approaches.

### System Overview

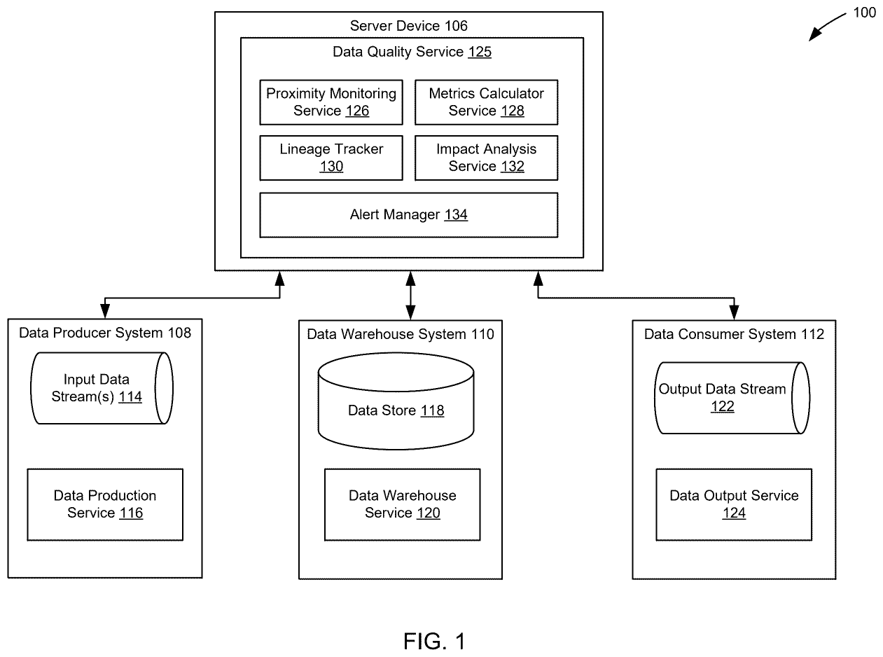

FIG. 1 illustrates a network infrastructure 100 configured to implement one or more aspects of various embodiments. As shown, the network infrastructure 100 includes a server device 106, a data producer system 108, a data warehouse system 110, and a data consumer system 112, each of which is connected via a communications network. The communications network can represent, for example, any technically feasible network or number of networks, including a wide area network (WAN) such as the Internet, a local area network (LAN), a Wi-Fi network, a cellular network, or a combination thereof.

The server device 106, data producer system 108, data warehouse system 110, and/or data consumer system 112 can represent one or more computing devices, such as rack servers, blade servers, tower servers, microservers, hyper-converged infrastructure servers, mainframe servers, and others, that are implemented by and accessible to an organization. The server device 106 executes, without limitations, a data quality service 125. The data quality service 125 includes one or more services or modules that perform various aspects of assessing and improving data quality associated with data flowing through the data producer system 108, data warehouse system 110, and data consumer system 112. For example, data quality service 125 includes proximity monitoring service 126, metrics calculator service 128, lineage tracker 130, impact analysis service 132, and alert manager 134. A more detailed explanation of the architecture of the data quality service 125, as well as the functionalities implemented by the data quality service 125, is provided below and in conjunction with FIGS. 1-4.

Data producer system 108 includes an input data stream 114 and executes a data production service 116. The input data stream 114 represents one or more incoming data streams that include events for which data or logs are stored in a data warehouse by data warehouse system 110. For example, an incoming data stream can represent login events for one or more user logins to a network-accessible service. The login event can include information such as a network address of the device from which the login event originates, a device type associated with the device, a username or other user identifier, geographic information associated with a location of the device, an application type or version through which the user is logging into the service, a session identifier, a timestamp, and other information associated with the login event. For example, the information stored in a data warehouse can include a user identity, a device identifier, a network address, a session identifier, and a timestamp. Another example of an input data stream 114 is a stream of playback events that correspond to when a user initiates or completes playback of a title in a streaming video service. In this example, the playback event can specify an account identifier, a user agent or device, a network address, a location from which the title is played back, and other information about the playback of a title. Input data stream 114 can be implemented as an event streaming platform that includes one or more real-time data pipelines. An example of such a platform includes Apache Kafka. Accordingly, data producer system 108 writes events to the input data stream 114, which are provided to data warehouse system 110 for storage in a data store 118.

Another example of a data producer system 108 includes a system that generates security events associated with a network-accessible service. For example, a system can detect a network intrusion event and generate a log for the event. The log is provided to downstream systems such as the data warehouse system 110 of a data consumer system 112. For example, the log can be stored in a data store 118 by the data warehouse system 110. The alert manager 134 can generate an alert for downstream systems such as a data consumer system 112 associated with a network administrator, who can take action with respect to the alert. However, if a particular data producer system 108 generates low quality data, there is a risk that the notification is ignored, which reduces the utility of generating the notification.

Data production service 116 is an application or service executed by data producer system 108 that coordinates with proximity monitoring service 126 to conform the events that are generated by the data quality service 125 to one or more schemas or data governance rules. Proximity monitoring service 126 can define standardized logging patterns or structures, referred to herein as schemas, that are provided to data production service 116. The schemas specify specific structured formats, such as JSON or XML, as well as a logging format that can further specify essential metadata, such as timestamps, event severity levels, and source identifiers that identify the data producer system 108, and other metadata. Accordingly, the data producer system 108 receives a schema for the data producer system 108 from proximity monitoring service 126 and enforces the schema on the events that are output by data producer system 108 for storage by data warehouse system 110.

A schema can be defined by a user and transmitted by proximity monitoring service 126 to data production service 116, which enforces the schema on the events that are output by data producer system 108 to data warehouse system 110. The schema can define the scenarios that lead to event generation or that require events to be written to input data stream 114. Additionally, proximity monitoring service 126 can maintain a registry of versioned data schemas that operate as a single source or truth for data structure definitions for data that is written to input data stream 114. In this way, data producer system 108, data warehouse system 110, and data consumer system 112 can all access a given schema for data that is written to input data stream 114 and output to data warehouse system 110.

Proximity monitoring service 126 can also specify one or more data governance rules that are enforced by data production service 116 on events that are written onto input data stream 114. Data governance rules leverage domain-specific languages to encode data quality policies and compliance requirements into a rule definition that is provided to data production service 116. The data governance rule specifies the information security policies, data retention policies, or other data policies that are enforced by data production service 116 with respect to events written to input data stream 114. Again, proximity monitoring service 126 can operate as a single source of truth with respect to one or more data governance rules that are applied to data warehouse system 110, data consumer system 112, and data producer system 108.

Data warehouse system 110 comprises a system that operates as a data warehouse for data from the input data stream 114. Data warehouse system 110 includes, without limitation, a data store 118 and executes a data warehouse service 120. The data store 118 can represent any type of database or data storage in which data can be stored. For example, data store 118 can represent a relational database, a non-relational database, key-value storage, or other types of storage, storage networks, or storage arrays in which data can be housed or accessed.

Data warehouse service 120 is an application or service executed by data producer system 108 that stores the events from input data stream 114 to the data store 118. Additionally, data warehouse service 120 can also coordinate with metrics calculator service 128 and lineage tracker 130 to facilitate calculation of metrics regarding data quality and also track the consistency of the data stored in the data store 118.

In one embodiment, metrics calculator service 128 of the data quality service 125, once the events from input data stream 114 are stored in the data store 118, calculates metrics that quantify data quality metrics such as completeness, accuracy, timeliness, and consistency. The data quality metrics can include rolling aggregate metrics, or sliding time-window metrics, anomaly scores, or other data quality metrics. The data quality metrics are calculated based on the data stored in the data store 118. In some embodiments, the data quality metrics are computed continuously in-stream before being stored in a data store or a data warehouse In some examples, a sliding window of metrics is calculated for trend analysis, and z-scores are calculated to identify anomalies and to perform distribution analyses. Additionally, metrics calculator service 128 can employ statistical sampling techniques that adapt to the volume of data being output by the input data stream 114 and stored in the data store 118 due to data volume and velocity. Data accuracy metrics are calculated using reference data comparison techniques. Data timeliness metrics are calculated using moving averages that account for seasonal patterns so that seasonal variations are accounted for. Consistency metrics can utilize hash-based comparison techniques for cross-source validation so that inconsistencies between different shards of data can be detected. The metrics calculated by metrics calculator service 128 can be output to a visualization dashboard that can be accessed by users associated with data producer system 108, data warehouse system 110, data consumer system 112, or other users.

Lineage tracker 130 determines or maintains data provenance and/or changelogs by tracking data dependencies and metadata history. In one embodiment, lineage tracker 130 maintains a directed acyclic graph (DAG) data structure that captures transformation relationships so that backward and forward tracing of data flowing into and out of the data store 118 can be determined. In one embodiment, the DAG is augmented with versioning or version control capabilities (VCC) so that changes to the events that are output to data warehouse service 120 can be tracked over time.

Impact analysis service 132 is executed to perform probabilistic analysis to predict and quantify the effects of data quality variations throughout a data pipeline. The impact analysis service 132 can utilize a Bayesian network that generates predictions based on interdependencies between data quality metrics calculated by metrics calculator service 128. In one embodiment, impact analysis service 132 utilizes a real-time feedback loop that ingests the metrics calculated by metrics calculator service 128 as well as performance data associated with one or more of the data producer system 108, data warehouse system 110, or data consumer system 112 to generate increasingly accurate predictions related to data quality variations over time. For example, the impact analysis service 132 can utilize Monte Carlo simulations that model potential service quality degradation based on the metrics calculated by metrics calculator service 128. The simulations can generate one or more confidence intervals for quality metrics output by metrics calculator service 128 and also utilize sensitivity analysis based on the metrics. The predictions can be output to a visualization dashboard that can be viewed by one or more users and used to monitor performance of the data producer system 108, data warehouse system 110, and/or data consumer system 112.

In another embodiment, impact analysis service 132 can utilize a trained machine learning model that generates predictions of service quality degradation based on the metrics calculated by metrics calculator service 128. The predictions can be output to the visualization dashboard or provided to data consumer systems 112 by the alert manager 134. The machine learning model can be trained using supervised learning based on a labeled training set in which metrics indicating service quality degradation are labeled as metrics that indicate service quality degradation. The training data set can also include metrics that do not indicate service quality degradation and are also labeled as metrics that do not indicate service quality degradation. The trained machine learning model can also be trained using semi-supervised learning where the machine learning model utilizes a small number of labeled examples in a training data set along with a larger set of unlabeled examples. The machine learning model can also be trained using self-supervised learning where the machine learning model creates labels based on a training data set

Alert manager 134 is executed to facilitate a notification architecture that sends notifications to downstream users, such as a data consumer system 112, relating to system performance based on the metrics generated by metrics calculator service 128 or predictions generated by impact analysis service 132. The notifications are also based on events stored in the data store 118 that are received from input data stream 114. The notifications can extend beyond threshold-based alerting used in traditional techniques. In one embodiment, alert manager 134 can implement a trained machine learning model can generate alerts based on historical patterns of metrics generated by metrics calculator service 128 and/or operational dependencies between data producer system 108, data warehouse system 110, and/or data consumer system 112.

For example, the machine learning model can be trained using supervised learning in which the model is trained based on a labeled set of data including previous alerts provided to a downstream user or system. For example, a set of historical alerts can be labeled as useful or unuseful, read or unread, actionable or unactionable, or with other types of labels that categorize the historical alerts positively or negatively. Accordingly, the machine learning model can be trained to generate subsequent alerts based on a training process using the set of training data. In some embodiments, the machine learning model is trained using self-supervised or semi-supervised learning in which the machine learning model creates labels from a set of historical alerts based on whether a downstream user or system interacts with a given alert. The machine learning model can also be trained using supervised learning based on a reward function that is related to downstream system engagement of an alert. In one embodiment, alert manager 134 aggregates related alerts for a given system into a subset or a single set of alerts to reduce alert fatigue for a downstream user or system, such as a data consumer system 112.

In one embodiment, alert manager 134 also utilizes a threshold management subsystem that adapts to seasonal patterns and evolving data characteristics when generating alerts based on events stored in the data store 118. An adaptive approach ensures that notification remains relevant and effective as data volumes and patterns change over time. For example, during periods of high usage, there is a greater quantity of potential notifications than during periods of lower usage. Accordingly, the alert manager 134 maintains a threshold version history, enabling retrospective analysis of alert effectiveness and optimization of threshold parameters by users. The alert manager 134 also leverages historical alerts to adjust alerting thresholds via a feedback loop. In other words, depending upon the volume of historical alerts or user engagement with historical alerts, the alert manager 134 can adjust alerting the degree to which the alert manager 134 generates alerts.

Data consumer system 112 comprises a system that operates as a downstream consumer of events stored in the data store 118 as well as alerts generated by alert manager 134. For example, data consumer system 112 can represent a system operated by users to access visualization dashboards to monitor the health of systems operating user-facing systems, such as one or more data producer systems 108. The data consumer system 112 can ingest information stored in the data store 118 as well as alerts from alert manager 134 to provide analytics, visualizations, debugging tools, or other systems and applications that rely upon events that are generated by a data producer system 108 and stored in the data store 118. Data warehouse system 110 includes, without limitation, an output data stream 122 and executes a data output service 124.

A data consumer system 112 can be associated with a network administrator tasked with monitoring and/or responding to alerts generated by alert manager 134. For example, alert manager 134 can generate alerts or notifications in response to data from input data stream 114. These alerts can be visualized in a user interface via the data consumer system 112 so that the network administrator can take action with respect to the alert.

As another example, a data consumer system 112 could also include a system that generates usage reports based on data stored in the data store 118 of data warehouse system 110. Accordingly, generating accurate usage reports can require data to be stored in the data store 118 according to a specific schema. Therefore, a schema provided by data quality service 125 to data producer system 108 can result in more accurate usage reports that are generated by downstream systems like data consumer system 112.

Data warehouse service 120 is an application or service executed by data producer system 108 that stores the events from input data stream 114 to the data store 118. Additionally, data warehouse service 120 can also coordinate with metrics calculator service 128 and lineage tracker 130 to facilitate the calculation of metrics regarding data quality and also track the consistency of the data stored in the data store 118.

The output data stream 122 represents one or more output data streams that includes events or data corresponding to events stored in the data store 118 and for which data quality service 125 generates an output stream for downstream consumption. The output stream can include alerts generated by the alert manager 134, metrics generated by metrics calculator service 128, lineage tracker 130, or impact analysis service 132, and other events or logs. For example, an output data stream can also correspond to login events for one or more user logins to a network-accessible service. Another example of data on the output data stream 122 also includes a stream of playback events that correspond to when a user initiates or completes playback of a title in a streaming video service. Output data stream 122 can be implemented as an event streaming platform that includes one or more real-time data pipelines. An example of such a platform includes Apache Kafka. Accordingly, data output service 124 writes events to the output data stream 122.

Data output service 124 formats data for one or more data consumer use-cases. Additionally, data output service 124 can also ensure that events stored in the data store 118 are delivered only once to a given data consumer. Further, data output service 124 generates visualizations corresponding to data on the output data stream 122. The visualizations can be generated based on events stored in the input data stream 114 as well as alerts generated by alert manager 134.

### Server Device Overview

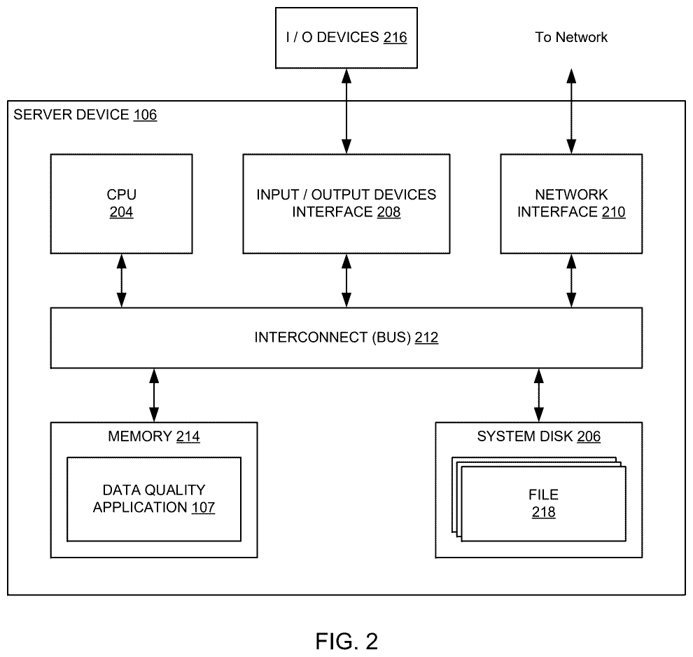

FIG. 2 is a more detailed illustration of a server device 106 of FIG. 1, according to various embodiments. As shown, the server device 106 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as data quality service 125, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 can include one or more buttons, a keyboard, a mouse, and/or other input devices. The I/O devices interface 208 is further configured to receive output data from the CPU 204 via the interconnect 212 and transmit the output data to the I/O devices 216.

The system disk 206 can include one or more hard disk drives, solid state storage devices, or similar storage devices. The system disk 206 is configured to store non-volatile data such as files 218 (e.g., audio files, video files, subtitles, application files, software libraries, etc.). In some embodiments, the network interface 210 is configured to operate in compliance with the Ethernet standard.

The system memory 214 includes the data quality service 125. In a clustered environment, data quality service 125 on each server device 106 can be responsible for executing various operations to ensure the server device 106 effectively participates with other server devices 106 in the cluster. In this regard, the data quality service 125 can be configured to service and/or respond to requests, commands, etc., received from other instances of data quality service 125. The data quality service 125 can also implement operations that ensure the server device 106 is aware of its role within the cluster, maintain communication with other control servers 120, and contribute to collective tasks such as handling failovers, scaling resources, and the like. The data quality service 125 can also monitor the health of the server device 106, apply configuration updates, and coordinate state transitions to ensure that the server device 106 aligns with the overall performance, availability, and redundancy objectives of the cluster. It is noted that the foregoing examples are not meant to be limiting, and that the data quality service 125 can be configured to implement any number, type, form, etc., of operation(s), at any level of granularity, to effectively manage the functionality of the server device 106 both individually and collectively within the associated cluster, consistent with the scope of this disclosure.

### Storing Data Conforming to Schema and Data Governance Rules

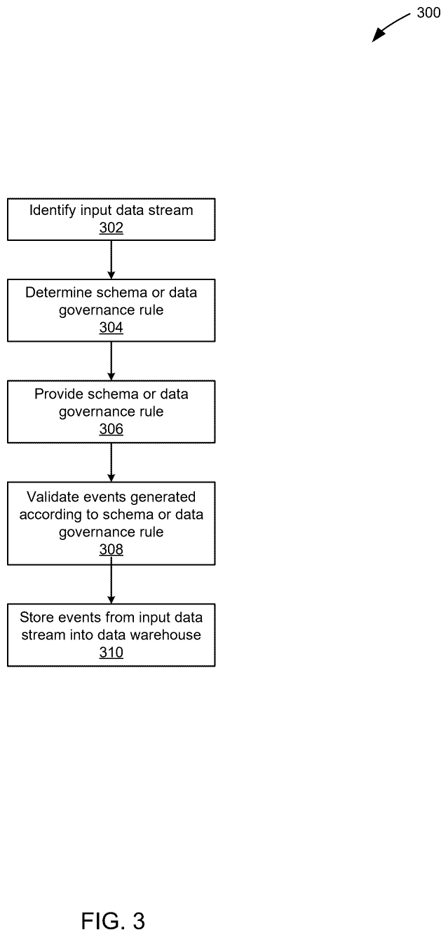

FIG. 3 sets forth a flow diagram of method steps for storing data from an input data stream 114 into a data store 118 maintained by data consumer system 112, according to various embodiments. As shown in FIG. 3, a method 300 begins at step 302, where the data quality service 125 receives and identifies data corresponding to one or more events in an input data stream 114. Again, the input data stream 114 can include information related to events occurring in a network-accessible service, such as a streaming service. For example, the input data stream 114 can include login events for one or more user logins to a network-accessible service. The login event can include information such as a network address of the device from which the login event originates, a device type associated with the device, a username or other user identifier, geographic information associated with a location of the device, an application type or version through which the user is logging into the service, a session identifier, a timestamp, and other information associated with the login event. Another example of an input data stream 114 is a stream of security-related events occurring in a network-accessible service. Security-related events can include suspected denial-of-service attacks, unsuccessful login events, and other security events. An input data stream 114 could also include playback events that correspond to when a user initiates or completes playback of a title in a streaming video service. In this example, the playback event can specify an account identifier, a user agent or device, a network address, a location from which the title is played back, and other information about the playback of a title. Input data stream 114 can be implemented as an event streaming platform that includes one or more real-time data pipelines.

At step 304, data quality service 125 identifies a schema or a data governance rule that corresponds to the data in the input data stream 114. Schemas specify specific structured formats, logging formats, metadata formats, metadata content, or other aspects of how the data should be formatted by a data producer system 108 for storage by the data warehouse system 110. A data governance rule can utilize domain-specific languages to encode data quality policies and compliance requirements into a rule definition that is provided to data production service 116. The data governance rule specifies the information security policies, data retention policies, or other data policies that are enforced by data production service 116 with respect to events written to input data stream 114. At step 306, the method 300 transmits the schema or data governance rule to the data producer system 108 associated with the input data stream 114.

At step 308, data quality service 125 can validate that the events provided to data warehouse system 110 and stored in the data store 118 correspond to the provided schema or data governance rule. In one embodiment, the data production service 116 on the data producer system 108 can validate the data provided to data warehouse system 110 according to the schema or data governance rule.

At step 310, data quality service 125 facilitates storage of the events from the input data stream 114 into the data store 118. In some embodiments, data warehouse service 120 stores the events from the input data stream 114 into data store 118. Once the events from the input data stream 114 are stored into the data store 118, data quality service 125 can calculate one or more data quality metrics and generate one or more alerts for downstream users, such as data consumer system 112.

### Generating Data Quality Metrics

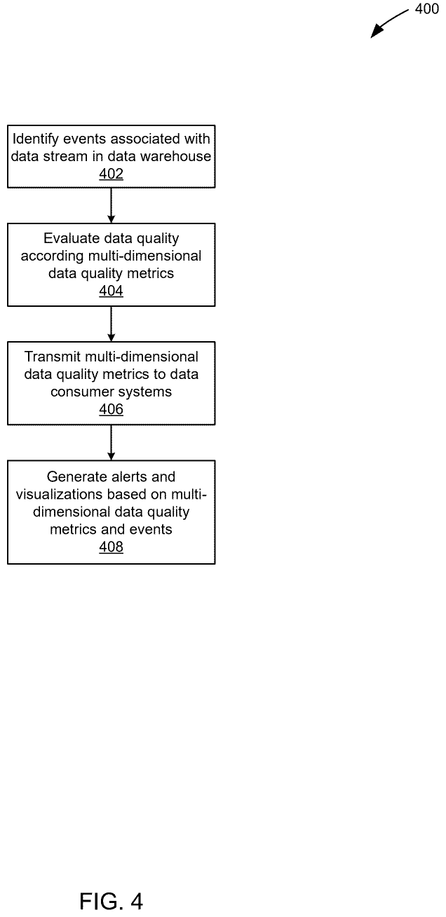

FIG. 4 sets forth a flow diagram of method steps for generating one or more data quality metrics based on data from an input data stream 114, according to various embodiments. As shown in FIG. 4, a method 400 begins at step 402, where data quality service 125 identifies one or more events associated with an input data stream 114 that are stored in the data store 118 by the data warehouse service 120. As noted above, the events stored in the data store 118 are stored according to a schema or data governance rules provided by proximity monitoring service 126 to data producer system 108.

At step 404, data quality service 125 evaluates data quality of the data from the input data stream 114 according to multi-dimensional data quality metrics. In one embodiment, data quality service 125 calculates one or more data quality metrics corresponding to the events stored in the data store 118. The data quality metrics can quantify completeness, accuracy, timeliness, and consistency. The data quality metrics can include rolling aggregate metrics, or sliding time-window metrics, anomaly scores, or other data quality metrics. Additionally, the data quality metrics are computed prior to storing the data quality metrics into a data store. The data quality metrics are calculated based on the data stored in the data store 118. In some examples, a sliding window of metrics is calculated for trend analysis, and z-scores are calculated to identify anomalies and to perform distribution analyses to determine completeness. Metrics calculator service 128 can employ statistical sampling techniques that adapt to the volume of data being output by the input data stream 114 and stored in the data store 118 due to data volume and velocity to assess completeness of the data from the input data stream 114 that is stored in data store 118. Data accuracy metrics are calculated using reference data comparison techniques. Data timeliness metrics are calculated using moving averages that account for seasonal patterns so that seasonal variations are accounted for. Consistency metrics can utilize hash-based comparison techniques for cross-source validation so that inconsistencies between different shards of data can be detected.

In some embodiments, impact analysis service 132 performs probabilistic analysis to predict and quantify the effects of data quality variations throughout a data pipeline. The probabilistic analysis can be used to forecast service degradation. The impact analysis service 132 can utilize a Bayesian network that generates predictions based on interdependencies between data quality metrics calculated by metrics calculator service 128. In one embodiment, impact analysis service 132 utilizes a real-time feedback loop that ingests the metrics calculated by metrics calculator service 128 as well as performance data associated with one or more of the data producer system 108, data warehouse system 110, or data consumer system 112 to generate increasingly accurate predictions related to data quality variations over time. For example, the impact analysis service 132 can utilize Monte Carlo simulations that model potential service quality degradation based on the metrics calculated by metrics calculator service 128. The simulations can generate one or more confidence intervals for quality metrics output by metrics calculator service 128 and also utilize sensitivity analysis based on the metrics. The predictions can be output to a visualization dashboard that can be viewed by one or more users and used to monitor performance of the data producer system 108, data warehouse system 110, and/or data consumer system 112.

At step 406, data quality service 125 transmits the multi-dimensional data quality metrics to a downstream consumer, such as data consumer system 112. At step 408, data quality service 125 can generate alerts and visualizations based on the data quality metrics. The alerts can be generated by alert manager 134 and distributed to downstream data consumer systems 112. Additionally, the data quality metrics can be incorporated into one or more visualizations for downstream users. For example, the metrics calculated by metrics calculator service 128 can be output to a visualization dashboard that can be accessed by users associated with data producer system 108, data warehouse system 110, data consumer system 112, or other users.

In some embodiments, alert manager 134 generates alerts to system performance based on the metrics generated by metrics calculator service 128 or predictions generated by impact analysis service 132. The notifications are also based on events stored in the data store 118 that are received from input data stream 114. A trained machine learning model can generate alerts based on historical patterns of metrics generated by metrics calculator service 128 and/or operational dependencies between data producer system 108, data warehouse system 110, and/or data consumer system 112. In one embodiment, alert manager 134 aggregates related alerts for a given system into a subset or a single set of alerts to reduce alert fatigue for a downstream user or system, such as a data consumer system 112. In one embodiment, alert manager 134 also utilizes a threshold management subsystem that adapts to seasonal patterns and evolving data characteristics when generating alerts based on events stored in the data store 118. An adaptive approach ensures that notification remains relevant and effective as data volumes and patterns change over time.

In sum, the embodiments set forth techniques for assessing the quality of data that is generated in a network-accessible service, such as a streaming video service. Data corresponding to events occurring in a network-accessible service is generated by data producer systems. The event data is stored in a data warehouse. Data quality metrics that quantify completeness, freshness, accuracy, and consistency are calculated. Downstream systems can receive information about data quality as well as alerts that can be configured based on the event data that is stored in the data warehouse.

One technical advantage of the disclosed techniques relative to the prior art is that the disclosed techniques provide a mechanism to monitor and improve the quality of data that is reported by data producers in a streaming service. The disclosed techniques provide a proximity-oriented monitoring strategy so that data quality can be assessed by placing monitoring mechanisms with the data producers rather than with data consumers. The disclosed techniques also evaluate data quality using multiple dimensions that include completeness, freshness, accuracy, and consistency. The disclosed techniques also enable the assessment of data quality degradation based on probabilistic models that forecast downstream consequences of data quality degradation. As a result, alerts and notifications that are generated based on data generated by data producers is more reliable, resulting in enhanced reliability and responsiveness of streaming data pipelines.

These technical advantages represent one or more technological improvements over prior art approaches.

It will be appreciated that the server device 106, data quality service 125, and other components described above in conjunction with FIGS. 1-4 are illustrative, and that variations and modifications are possible. The connection topologies, including the number of CPUs and memories, may be modified as desired, and in certain embodiments, one or more components shown in FIGS. 1-4 may not be present. Further, in certain embodiments, one or more components shown in FIGS. 1-4 may be implemented as virtualized resources in a virtual computing environment and/or a cloud computing environment.

Aspects of the subject matter described herein are set out in the following numbered clauses.
1. In some embodiments, a computer-implemented method for generating data quality metrics comprises identifying an input data stream comprising a plurality of events, determining at least one of a schema or a data governance rule associated with the input data stream, providing the schema or data governance rule to the input data stream, wherein the input data stream outputs events according to the schema or the data governance rule, calculating a plurality of data quality metrics associated with the events from the input data stream that are stored in the data warehouse, and providing one or more alerts to a downstream data consumer based on the data quality metrics and the events stored in the data warehouse.
2. The computer-implemented method of clause 1, further comprising validating the events prior to storage in a data warehouse based on the at least one of the schema or data governance rule.
3. The computer-implemented method of clauses 1 or 2, wherein the plurality of data quality metrics quantify at least one of data completeness, data accuracy, data timeliness, or data consistency.
4. The computer-implemented method of any of clauses 1-3, further comprising determining data completeness of the events stored based on statistical sampling of the events, wherein the statistical sampling is based on a volume or velocity of event storage into a data warehouse.
5. The computer-implemented method of any of clauses 1-4, further comprising determining data accuracy of the events stored in a data warehouse based on at least one reference data comparison algorithm.
6. The computer-implemented method of any of clauses 1-5, further comprising determining data timeliness of the events stored in a data warehouse based on at least one moving average metric based on seasonal pattern data associated with the events.
7. The computer-implemented method of any of clauses 1-6, further comprising determining data consistency of the events stored in a data warehouse based on at least one of a hash-based comparison of the events or a cross-source validation of the events.
8. The computer-implemented method of any of clauses 1-7, further comprising determining a data lineage associated with the events stored in a data warehouse based on at least one transformation relationship associated with the events stored in the data warehouse.
9. The computer-implemented method of any of clauses 1-8, wherein the data lineage associated with the events stored in the data warehouse is stored in a directed acyclic graph that stores the at least one transformation relationship.
10. The computer-implemented method of any of clauses 1-9, wherein generating the one or more alerts to the downstream data consumer further comprises generating, via a trained machine learning model, the one or more alerts based on at least one of a historical alert pattern or an operational dependency associated with an event stored in a data warehouse.
11. In some embodiments, one or more non-transitory computer readable media store instructions that, when executed by one or more processors, cause the one or more processors to generating data quality metrics, by performing the steps of identifying an input data stream comprising a plurality of events, determining at least one of a schema or a data governance rule associated with the input data stream, providing the schema or data governance rule to the input data stream, wherein the input data stream outputs events according to the schema or the data governance rule, the events being stored in a data warehouse, calculating a plurality of data quality metrics associated with the events from the input data stream that are stored in the data warehouse, and generating one or more alerts to a downstream data consumer based on the data quality metrics and the events stored in the data warehouse.
12. The one or more non-transitory computer readable media of clause 11, wherein the instructions further comprise generating a data output stream based on the events stored in the data warehouse, the data output stream comprising the events and the data quality metrics.
13. The one or more non-transitory computer readable media of clauses 11 or 12, wherein the data output stream further comprises a data visualization dashboard, the data visualization dashboard providing a user interface for modification of the one or more alerts.
14. The one or more non-transitory computer readable media of any of clauses 11-13, further comprising validating the events prior to storage in the data warehouse based on the at least one of the schema or data governance rule.
15. The one or more non-transitory computer readable media of any of clauses 11-14, wherein the plurality of data quality metrics quantify at least one of data completeness, data accuracy, data timeliness, or data consistency.
16. The one or more non-transitory computer readable media of any of clauses 11-15, wherein the instructions further comprise determining data completeness of the events stored in the data warehouse based on statistical sampling of the events stored in the data warehouse based on a volume or velocity of event storage into the data warehouse.
17. The one or more non-transitory computer readable media of any of clauses 11-16, wherein the instructions further comprise determining data accuracy of the events stored in the data warehouse based on at least one reference data comparison algorithm.
18. The one or more non-transitory computer readable media of any of clauses 11-17, wherein the instructions further comprise determining data timeliness of the events stored in the data warehouse based on at least one moving average metric based on seasonal pattern data associated with the events.
19. The one or more non-transitory computer readable media of any of clauses 11-18, wherein the instructions further comprise determining data consistency of the events stored in the data warehouse based on at least one of a hash-based comparison of the events or a cross-source validation of the events.
20. In some embodiments, a computer system comprises one or more memories that include instructions, and one or more processors that are coupled to the one or more memories and, when executing the instructions, are configured to generating data quality metrics, by performing the operations of identifying an input data stream comprising a plurality of events, determining at least one of a schema or a data governance rule associated with the input data stream, providing the schema or data governance rule to the input data stream, wherein the input data stream outputs events according to the schema or the data governance rule, the events being stored in a data warehouse, calculating a plurality of data quality metrics associated with the events from the input data stream that are stored in the data warehouse, and generating one or more alerts to a downstream data consumer based on the data quality metrics and the events stored in the data warehouse

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating data quality metrics, the method comprising:
identifying an input data stream comprising a plurality of events;
determining at least one of a schema or a data governance rule associated with the input data stream;
providing the schema or data governance rule to the input data stream, wherein the input data stream outputs events according to the schema or the data governance rule;
calculating a plurality of data quality metrics associated with the events from the input data stream that are stored in the data warehouse; and
providing one or more alerts to a downstream data consumer based on the data quality metrics and the events stored in the data warehouse.

2. The computer-implemented method of claim 1, further comprising validating the events prior to storage in a data warehouse based on the at least one of the schema or data governance rule.

3. The computer-implemented method of claim 1, wherein the plurality of data quality metrics quantify at least one of data completeness, data accuracy, data timeliness, or data consistency.

4. The computer-implemented method of claim 3, further comprising determining data completeness of the events stored based on statistical sampling of the events, wherein the statistical sampling is based on a volume or velocity of event storage into a data warehouse.

5. The computer-implemented method of claim 3, further comprising determining data accuracy of the events stored in a data warehouse based on at least one reference data comparison algorithm.

6. The computer-implemented method of claim 3, further comprising determining data timeliness of the events stored in a data warehouse based on at least one moving average metric based on seasonal pattern data associated with the events.

7. The computer-implemented method of claim 3, further comprising determining data consistency of the events stored in a data warehouse based on at least one of a hash-based comparison of the events or a cross-source validation of the events.

8. The computer-implemented method of claim 1, further comprising determining a data lineage associated with the events stored in a data warehouse based on at least one transformation relationship associated with the events stored in the data warehouse.

9. The computer-implemented method of claim 8, wherein the data lineage associated with the events stored in the data warehouse is stored in a directed acyclic graph that stores the at least one transformation relationship.

10. The computer-implemented method of claim 1, wherein generating the one or more alerts to the downstream data consumer further comprises generating, via a trained machine learning model, the one or more alerts based on at least one of a historical alert pattern or an operational dependency associated with an event stored in a data warehouse.

11. One or more non-transitory computer readable media storing instructions that, when executed by one or more processors, cause the one or more processors to generating data quality metrics, by performing the steps of:
identifying an input data stream comprising a plurality of events;
determining at least one of a schema or a data governance rule associated with the input data stream;
providing the schema or data governance rule to the input data stream, wherein the input data stream outputs events according to the schema or the data governance rule, the events being stored in a data warehouse;
calculating a plurality of data quality metrics associated with the events from the input data stream that are stored in the data warehouse; and
generating one or more alerts to a downstream data consumer based on the data quality metrics and the events stored in the data warehouse.

12. The one or more non-transitory computer readable media of claim 11, wherein the instructions further comprise generating a data output stream based on the events stored in the data warehouse, the data output stream comprising the events and the data quality metrics.

13. The one or more non-transitory computer readable media of claim 11, wherein the data output stream further comprises a data visualization dashboard, the data visualization dashboard providing a user interface for modification of the one or more alerts.

14. The one or more non-transitory computer readable media of claim 11, further comprising validating the events prior to storage in the data warehouse based on the at least one of the schema or data governance rule.

15. The one or more non-transitory computer readable media of claim 11, wherein the plurality of data quality metrics quantify at least one of data completeness, data accuracy, data timeliness, or data consistency.

16. The one or more non-transitory computer readable media of claim 15, wherein the instructions further comprise determining data completeness of the events stored in the data warehouse based on statistical sampling of the events stored in the data warehouse based on a volume or velocity of event storage into the data warehouse.

17. The one or more non-transitory computer readable media of claim 15, wherein the instructions further comprise determining data accuracy of the events stored in the data warehouse based on at least one reference data comparison algorithm.

18. The one or more non-transitory computer readable media of claim 15, wherein the instructions further comprise determining data timeliness of the events stored in the data warehouse based on at least one moving average metric based on seasonal pattern data associated with the events.

19. The one or more non-transitory computer readable media of claim 15, wherein the instructions further comprise determining data consistency of the events stored in the data warehouse based on at least one of a hash-based comparison of the events or a cross-source validation of the events.

20. A computer system, comprising:
one or more memories that include instructions; and
one or more processors that are coupled to the one or more memories and, when executing the instructions, are configured to generating data quality metrics, by performing the operations of:
identifying an input data stream comprising a plurality of events;
determining at least one of a schema or a data governance rule associated with the input data stream;
providing the schema or data governance rule to the input data stream, wherein the input data stream outputs events according to the schema or the data governance rule, the events being stored in a data warehouse;
calculating a plurality of data quality metrics associated with the events from the input data stream that are stored in the data warehouse; and
generating one or more alerts to a downstream data consumer based on the data quality metrics and the events stored in the data warehouse.
